(19) United States
(12) Patent Application Publication
(10) Pub. No.: US 2020/0130504 A1
(43) Pub. Date: Apr. 30, 2020

(54) Gas cap with built-in funnel for small engines

(71) Applicant: Edward Roy, Dover, NH (US)

(72) Inventor: Edward Roy, Dover, NH (US)

(21) Appl. No.: 16/172,791

(22) Filed: Oct. 27, 2018

(51) Int. Cl. B60K 15/04; B67C 11/02

(52) U.S. Cl. CPC B60K 15/0406; B67C 2011/20; B67C 11/02

(57) ABSTRACT

The invention is directed to a gas cap with built-in funnel for small engines. The gas cap provides a compact funnel of sufficient size to speed the refueling process and prevent spills, and may further provide a valve to prevent the escape of gasoline fumes from the fuel tank.

This application relates back to, and claims the priority of Provisional Patent Application No. 62/578,430 filed on Oct. 30, 2017.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to small engine accessories, and in particular to a gas cap with built-in funnel for small engines. The process of filling the fuel tank on a small engine can be time consuming and frequently results in spills. Depending on the application of the engine, this may result in a fire hazard or simply an annoying odor as the spilled fuel evaporates. Many owners of lawnmowers, outboard motors, and other devices with small engines use funnels to prevent spills and speed the refueling process, but this is one more piece of equipment to keep track of and store when not in use.

A search of the prior art reveals various devices which have been developed to address this set of problems, or related problems. None are closely related to the present invention, but several include features which resemble those of the present invention. Each has proven to be less than satisfactory for the present purpose in its own way.

E-Z funnel for vehicles, U.S. Pat. No. 6,460,582 (priority Jan. 22, 2002), provides a funnel designed for providing accommodations for the the consumer, especially the disabled. By adapting the funnel at the base with a cut-out wedged end and drilling a hole through the center of gas cap the funnel can now be put together and attached permanently with epoxy glue that is non-soluble. A user of this funnel can now screw it onto the gas spout of their vehicle and with it's special design, the gas goes right into the tank without any back splash. Also their hands are free to hold the container they are using to carry the gas in.

Combined gas cap and funnel, U.S. Design Pat. No. D269425 (priority Jun. 21, 1983), provides a combined gas cap and funnel.

Fuel tank filler neck and method of manufacturing same, U.S. Pat. No. 6,588,459 (priority Dec. 3, 1999), provides a fuel tank filler neck to reduce the escape of gasoline vapor from an automobile fuel tank system and is leak tight. The filler neck is configured to receive a fuel supply nozzle. The filler neck includes a one-piece seamless funnel member having a tubular body and an elongated tubular member. The funnel member defines in off-set axial relation a relatively large inlet opening adapted for attachment to a receptor for the nozzle and a relatively small necked down outlet opening adapted for attachment to the inlet of an elongated tubular member. The tubular member is adapted to be in communication with the fuel tank. A method for manufacturing the fuel tank filler neck is also disclosed. (See also U.S. Pat. No. 7,059,365.)

Combination funnel and siphon, U.S. Pat. No. 4,273,166 (priority Oct. 4, 1979), provides a funnel-shaped receptacle with a neck portion adapted for sealing attachment to the neck portion of a gas tank, the neck portion having disposed therein a rigid tube running vertically from the mouth of the neck and then horizontally to an outer side of the receptacle. A flexible tube is connected to the outside portion of the rigid tube and runs to the upper portion of the receptacle, where it is detachably secured to a lip member integrally formed on the receptacle. A metal screen is disposed within the receptacle across the neck portion thereof. When fuel overflows into the receptacle during the pouring operation, pouring is discontinued and the flexible tube is detached from the receptacle and inserted into the pouring container, after it has been placed on the ground, to thereby cause siphoning of the overflow fuel back into the pouring container, to completely eliminate waste or spillage of fuel.

Fuel filler tube assembly and manufacturing method, U.S. Pat. No. 7,048,019 (priority Sep. 30, 2003), provides a method of forming a filler tube which includes forming a funnel insert, forming a funnel portion in a first end of a filler tube, and joining the funnel insert and the funnel portion of the filler tube. The funnel portion includes a transition portion configured to induce a swirl to passing fuel for venting vapors from the gas tank during fuel filling. A fuel filler tube assembly includes the funnel portion including a tubular body defining a larger inlet and a smaller outlet, the position of the inlet relative the outlet and an internal configuration of the tubular body therebetween inducing a swirl to inventing vapors from fuel flowing through the tubular body. The larger inlet receives a funnel insert including a nozzle opening positioned to cooperate with the internal configuration of the tubular body.

If a device were available which eliminated the need for a separate funnel, it would be very useful and would be well received. A gas cap with built-in funnel for small engines, which provides a compact funnel of sufficient size to speed the refueling process and prevent spills, would resolve this problem.

### SUMMARY OF THE INVENTION

Accordingly, the invention is directed to a gas cap with built-in funnel for small engines. The gas cap provides a compact funnel of sufficient size to speed the refueling process and prevent spills, and may further provide a valve to prevent the escape of gasoline fumes from the fuel tank.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 is a side perspective view of the first exemplary embodiment, displaying the gas cap 10, and the funnel 11.

FIG. 2 is a top perspective view of the first exemplary embodiment, displaying the gas cap 10, and the funnel 11.

FIG. 3 is a top view of the first exemplary embodiment, displaying the funnel 11.

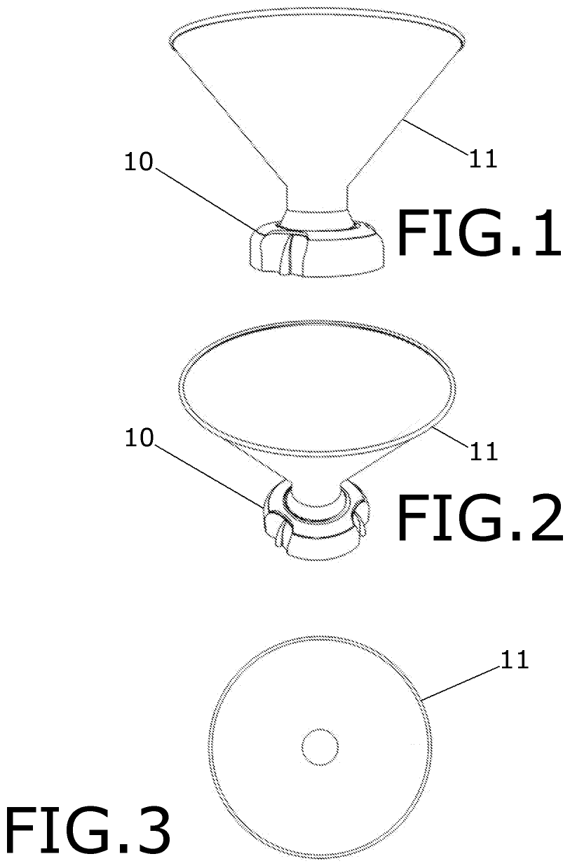

### DETAILED DESCRIPTION OF THE INVENTION

Referring now to the invention in more detail, the invention is directed to a gas cap 10 with built-in funnel 11 for small engines.

It is intended for the invention to be installed as an after-market modification by the owner of a lawnmower or other device with a small engine. An alternate embodiment, intended for installation as original equipment by the manufacturer of the device, is also contemplated.

The first exemplary embodiment is comprised of a gas cap 10 which is in most respects identical to a conventional gas cap on a small engine, secured to the top surface of the fuel tank with screw threads. This specification will focus on the ways in which the invention differs from and improves upon a conventional gas cap design.

The first exemplary embodiment is further comprised of a funnel 11 which is permanently affixed to the center of the top surface of the cap 10, such that when fuel is poured into the funnel 11, the fuel empties out through the gas cap 10 and into the fuel tank of the small engine. Optionally, the gas cap 10 may further provide a valve to prevent the escape of gasoline fumes from the fuel tank, and to protect the contents of the fuel tank from being contaminated by rainwater.

To use the first exemplary embodiment, the user installs the gas cap 10 and fills the fuel tank by pouring fuel into the funnel 11. The fuel flows downward through the funnel 11 and the gas cap 10, into the fuel tank.

The gas cap 10, the funnel 11, and the valve are preferably manufactured from rigid, durable materials, such as plastic, steel, and aluminum alloy. Components and methods listed above are preferable, but artisans will recognize that alternate components and methods could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A gas cap with built-in funnel for small engines, which is in most respects identical to a conventional gas cap on a small engine, secured to the top surface of the fuel tank with screw threads, and is further comprised of a funnel which is permanently affixed to the center of the top surface of the cap, such that when fuel is poured into the funnel, the fuel empties out through the gas cap and into the fuel tank of the small engine.

2. The gas cap of claim 1, wherein optionally, the gas cap may further provide a valve to prevent the escape of gasoline fumes from the fuel tank, and to protect the contents of the fuel tank from being contaminated by rainwater.

3. The gas cap of claim 1, wherein the user installs the gas cap 10 and fills the fuel tank by pouring fuel into the funnel. The fuel flows downward through the funnel and the gas cap, into the fuel tank.

4. The gas cap of claim 1, wherein the gas cap, the funnel, and the valve are preferably manufactured from rigid, durable materials, such as plastic, steel, and aluminum alloy.
